(19) United States
(12) Patent Application Publication
(10) Pub. No.: US 2019/0155246 A1
(43) Pub. Date: May 23, 2019

(54) EVALUATION SYSTEM AND EVALUATION METHOD

(71) Applicant: INSTITUTE FOR INFORMATION INDUSTRY, TAIPEI (TW)

(72) Inventors: Kun-Yu LIN, Changhua County (TW); Hung-Sheng CHIU, Taichung City (TW); Chih-Chieh LIN, Taipei City (TW); Chien-Chih LU, Taichung City (TW); Cheng-Tsai LAI, Nantou County (TW); Jun-Ren CHEN, Taichung City (TW)

(21) Appl. No.: 15/933,390

(22) Filed: Mar. 23, 2018

(30) Foreign Application Priority Data
Nov. 17, 2017 (TW) 106139978

(51) Int. Cl. G05B 19/401; B23Q 17/22; G01L 5/00; B21J 9/20

(52) U.S. Cl. CPC G05B 19/401; B23Q 17/2233; B21J 9/20; G01L 5/0095; G01L 5/0038

(57) ABSTRACT

An evaluation system applied on shaping machine, in which the shaping machine has a controller and an electricity meter. The evaluation system includes a parameter obtaining device and an evaluation device. The parameter obtaining device communicatively coupled to the controller and the electricity meter. The parameter obtaining device is configured to obtain a plurality of parameter data regarding a machining program from the controller and the electricity meter. The evaluation device is electrically coupled to the parameter obtaining device, the evaluation device configured to transform the parameter data into numerical parameters to extract a bolster plate position value and a motor current value, multiply the bolster plate position value and the motor current value with weights and sum up the weighted bolster plate position value and the weighted motor current value as an evaluation score.

### CROSS-REFERENCE TO RELATED APPLICATION

This application claims priority to Taiwan Application Serial Number 106139978, filed on Nov. 17, 2017, which is herein incorporated by reference.

### BACKGROUND

### Field of Invention

Present disclosure relates to an evaluation system and an evaluation method. More particularly, present disclosure relates to the evaluation system and the evaluation method applied on shaping machines.

### Description of Related Art

In many industries, shaping manufacturing machines are in great demands, and the stamping press machine is one of these machines. However, it is difficult to directly monitor the stamping press machine and the materials being processed at the time that the machining program is performed. The operator can only set corresponding parameters in advance, and obtain results after the machining program is done. In this case, the operators and managers cannot get immediate feedbacks when the machining program is performed. Therefore, it is difficult for the operators and managers to evaluate each machining program when the machine is in operation.

Aiming to solve aforementioned problems, an evaluation system and an evaluation method for shaping machines are provided.

### SUMMARY

The disclosure provides an evaluation system, which is applied on a shaping machine having a controller and an electricity meter. The evaluation system includes a parameter obtaining device and an evaluation device. The parameter obtaining device is communicatively coupled to the controller and the electricity meter. The parameter obtaining device is configured to obtain a plurality of pieces of parameter data regarding a machining program from the controller and the electricity meter. The evaluation device is electrically coupled to the parameter obtaining device, the evaluation device is configured to transform the parameter data into numerical parameters, extract a bolster plate position value and a motor current value from the numerical parameters, multiply the bolster plate position value with a first weight, multiply the motor current value with a second weight, and sum up the weighted bolster plate position value and the weighted motor current value as an evaluation score.

Another aspect of present disclosure is to provide an evaluation method. The evaluation method is applied on a shaping machine having a controller and an electricity meter. The monitoring method comprises following steps: obtaining, by a parameter obtaining device, a plurality of pieces of parameter data regarding a machining program from the controller and the electricity meter; transforming, by an evaluation device, the parameter data into numerical parameters and extracting a bolster plate position value and a motor current value from the numerical parameters; and multiplying, by the evaluation device, the bolster plate position value with a first weight and multiplying the motor current value with a second weight, and summing up the weighted bolster plate position value and the weighted motor current value as an evaluation score.

It is to be understood that both the foregoing general description and the following detailed description are by examples, and are intended to provide further explanation of the disclosure as claimed.

### BRIEF DESCRIPTION OF THE DRAWINGS

Present disclosure can be more fully understood by reading the following detailed description of the embodiment, with reference made to the accompanying drawings as follows:

FIG. 1 is a schematic diagram of an evaluation system according to one embodiment of the present disclosure;

FIG. 2 is a schematic diagram of an evaluation system according to one embodiment of the present disclosure;

FIG. 3 is a schematic diagram of an evaluation setting table according to one embodiment of the present disclosure;

FIG. 4 is a schematic diagram of some evaluation graphs according to one embodiment of the present disclosure; and

FIG. 5 is a flow chart of an evaluation method according to some embodiments of present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, the terms “comprising,” “including,” “having,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

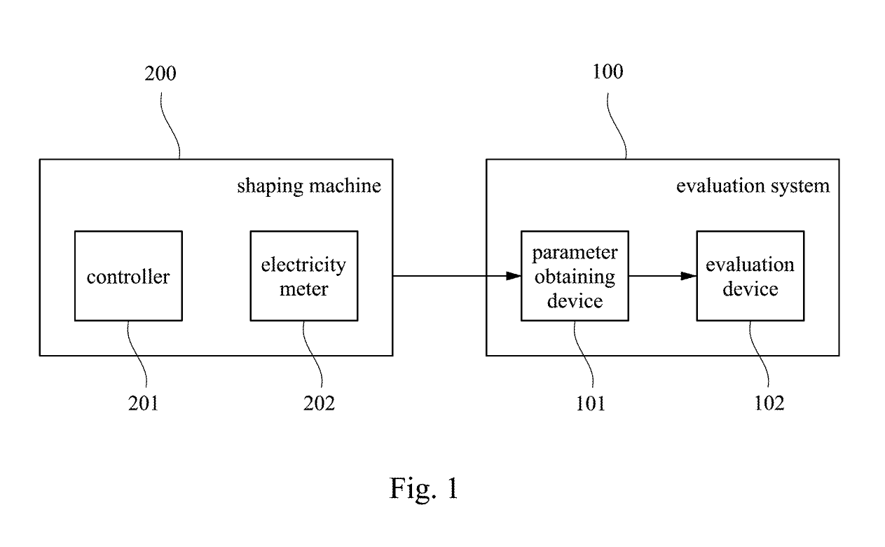

FIG. 1 is a schematic diagram of an evaluation system according to one embodiment of the present disclosure. As shown in FIG. 1, in the embodiment, the evaluation system 100 is communicatively coupled to the shaping machine 200. It is noted, being communicatively coupled means that the evaluation system 100 and the shaping machine 200 can interchange information with each other, and it is not limited to a direct connection via physical cables or an indirect connection via wireless communication. In the embodiment, the shaping machine 200 can be a stamping press machine, which is a machine configured to manufacture shaped parts by stamping metallic or some other materials with pressures. Usually, the stamping press machine is associated with some molds to establish punching shear processes, forming processes, deep drawing processes or metal forging processes.

In the embodiment, the shaping machine 200 includes a controller 201. The controller 201 can be a programmable logic controller (PLC), configured to control the shaping machine 200 to execute the machining programs. In one case, the shaping machine 200 is configured with a plurality of sensors, and the sensors are controlled and monitored by the controller 201. Therefore, applying a connection to the controller 201 can obtain information of some parameters regarding the machining programs. In the embodiment, the shaping machine 200 is configured with an execution button (not shown in the figure), which is electrically coupled to the controller 201. When the execution button is pressed by an operator, the controller 201 sends a control signal to drive a stamping part of the shaping machine 200 to execute a machining program. The control signal includes data regarding a plurality of parameters, in which said parameters are the control setting parameters when the controller 201 drives the stamping part. Typically, in a machining program, when the operator presses the execution button, the controller 201 sends the control signal to drive the stamping part, and the upper die setting on the stamping part travels from a beginning end to a terminal end, then the upper die matches the button die at the terminal end. Hence the material set between the upper die and the lower die can be pressed to form a shape as the inner of the dies. In most of the shaping machines 200, the direction extending from the beginning end to the terminal end is perpendicular to the horizontal surface that the shaping machine 200 stands on. Moreover, in the embodiment, the shaping machine 200 further includes the electricity meter 202. The electricity meter 202 is configured to obtain other parameter data from shaping machine 200, which is the motor current value driving the stamping part in the machining program. The electricity meter 202 can communicate with other devices to send out the parameter data it obtains. In some embodiments, the electricity meter 202 can be a digital electricity meter, a multifunction electricity meter or a smart electricity meter.

In the embodiment, the evaluation system 100 includes a parameter obtaining device 101 and an evaluation device 102, in which the parameter obtaining device 101 and the evaluation device 102 are electrically coupled. Though the parameter obtaining device 101, the evaluation system 100 is in communication with the controller 201 and the electricity meter 202 of the shaping machine 200. The parameter obtaining device 101 is configured to obtain a plurality of parameter data regarding at least one machining program from the controller 201 and the electricity meter 202. As mentioned, when the operator of the shaping machine 200 presses the execution button, the controller 201 can drive the stamping part to perform the machining program according to said parameters. In this case, the electricity meter 202 can measure the motor current value in the machining program. Therefore, in the machining program is executed, the parameter obtaining device 101 can obtain all the parameter data from the controller 201 and the electricity meter 202. When the parameter obtaining device 101 successfully obtains the parameter data from the controller 201 and the electricity meter 202, the parameter obtaining device 101 can send the parameter data to the evaluation device 102 of the evaluation system 100, and the parameter data will be processed by the evaluation device 102.

In the embodiment, when the evaluation device 102 of the evaluation system 100 receives the parameter data from the parameter obtaining device 101, the evaluation device 102 can establish a transform process to transform the parameter data into numerical parameters. Hence the numerical parameters regarding the machining program executed by the shaping machine 200 can be obtained. It is noted, the transform process is to process the parameter data with a predetermined rule, so that each control parameter in the parameter data can be turned to one numerical value within a fixed range. This makes calculations to the parameters much simple. For example, the evaluation device 102 can turn parameter data regarding one of the parameters into a score ranged from 0 to 100. In the embodiment, when the evaluation device 102 obtains these numerical parameters, the evaluation device 102 can select at least one of the numerical parameters and run a calculation on the selected numerical parameters to generate an evaluation score to the machining program. Moreover, to make the evaluation score more intuitive to the operators or the manager of the machine, each numerical parameter is assign with a weight. When the evaluation device 102 runs the calculation on the selected numerical parameters, each selected numerical parameter is multiplied with one corresponding weight, and all the weighted numerical parameters are accumulated as the evaluation score. It is noted, the weights being assigned to these numerical parameters are stored in a weigh table. When the calculation is run by the evaluation device 102, the evaluation device 102 can acquire the weights being stored in the weigh table.

In one embodiment, the evaluation device 102 can obtain some historical parameter data regarding at least one historical machining program performed by the shaping machine 200, then turn the historical parameter data to some numerical historical parameters. Then, the weights corresponding to the numerical parameters in aforesaid machining program can be determined, according to the related numerical historical parameters being extracted from the historical parameter data. It is to say, before the aforesaid machining program is executed, the shaping machine 200 should have executed several historical machining programs. In each time that the historical machining programs being executed, the parameter data corresponding to these historical machining programs can be obtained by the parameter obtaining device 101 and sent to the evaluation device 102. The evaluation device 102 can store all the parameter data as the historical parameter data. To meet the expectation of the operator or the manager of the shaping machine 200, the evaluation device 102 can determine the weights being assigned to the selected parameters so that the evaluation score will be presented in a range.

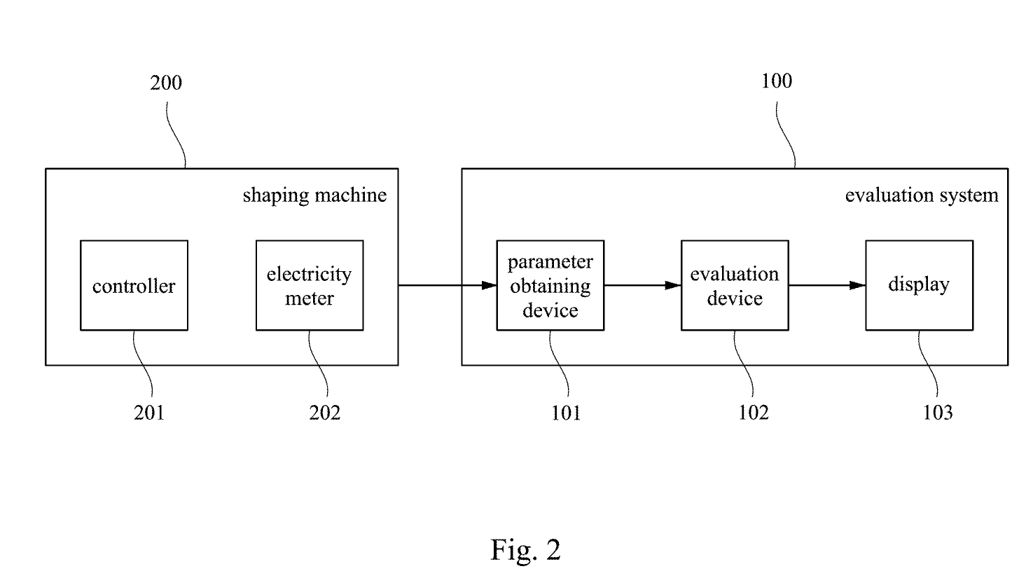

FIG. 2 is a schematic diagram of an evaluation system according to one embodiment of the present disclosure. As shown in FIG. 2, in one embodiment, the evaluation system 100 includes the parameter obtaining device 101, the evaluation device 102 and the display 103. The evaluation device 102 is configured to output a score graph corresponding to the evaluation score via the display 103. Through the display 103, it would be much intuitive for the operator or the manager of the shaping machine 200 to understand the evaluation score. In some embodiment, the score graph corresponding to the evaluation score further concludes a plurality of sub-graphs, in which the scores about the weighted numerical parameters are shown. In these sub-graphs, the occupancy rate of each weighted numerical parameters in the evaluation score can be revealed.

As shown in FIG. 1 and FIG. 2, in one embodiment, in the calculation that the evaluation device 102 generates the evaluation score, the evaluation device 102 can select the bolster plate position value and the motor current value from the numerical parameters, and obtain the weights corresponding to the bolster plate position value and the motor current. Then, the evaluation device 102 can multiply the bolster plate position value and the motor current value with corresponding weights, respectively, and accumulate the weighted bolster plate position value and the weighted motor current value as an evaluation score for this machining program. And the display 103 can display the score graph corresponding to the evaluation score. In the embodiment, the bolster plate position value indicates the variation of the bolster plate of shaping machine 200 in this machining program. The sensors settled on the shaping machine 200 can measure the bolster plate position value and send the bolster plate position value to the controller 201. Thus, the parameter obtaining device 101 can obtain parameter data corresponding to the bolster plate position value from the controller 201. The bolster plate position value can be used to evaluate the accuracy of the force applied by the bolster plate in the machining program. In the embodiment, the motor current value indicates the driving current that the motor of shaping machine 200 being provided, and the motor current value can be used to evaluate the energy consumption in this machining program. As mentioned, the parameter data corresponding to the motor current value is measured by the electricity meter 202 settled on the shaping machine 200.

As shown in FIG. 1 and FIG. 2, in another embodiment, in the calculation that the evaluation device 102 generates the evaluation score, the evaluation device 102 can select the bolster plate position value, the motor current value and the shaping pressure value from the numerical parameters, and obtain the weights corresponding to the bolster plate position value, the motor current value and the shaping pressure value. Then, the evaluation device 102 can multiply the bolster plate position value, the motor current value and the shaping pressure value with corresponding weights, respectively, and accumulate the weighted bolster plate position value, the weighted motor current value and the weighted shaping pressure value as an evaluation score for this machining program. And the display 103 can display the score graph corresponding to the evaluation score. In the embodiment, the shaping pressure value indicates the pressure that the stamping part of the shaping machine 200 performs in this machining program. The shaping pressure value can be obtained from the numerical parameters acquiring from the controller 201. It is noted, the shaping pressure value can be used to evaluate the accuracy of the force applied by the upper die in the machining program.

As shown in FIG. 1 and FIG. 2, in another embodiment, in the calculation that the evaluation device 102 generates the evaluation score, the evaluation device 102 can select the bolster plate position value, the motor current value and the shaping pressure value from the numerical parameters, and obtain the weights corresponding to the bolster plate position value, the motor current value and the shaping pressure value. Then, the evaluation device 102 can multiply the bolster plate position value, the motor current value and the shaping cycle time value with corresponding weights, respectively, and accumulate the weighted bolster plate position value, the weighted motor current value and the weighted shaping cycle time value as an evaluation score for this machining program. And the display 103 can display the score graph corresponding to the evaluation score. In the embodiment, the shaping cycle time value indicates the gap time between this machining program and the previous machining program performed by the shaping machine 200. It is noted, the shaping cycle time value can used to evaluate the machining programs performed by the shaping machine 200 in each predetermined time unit, then the uptime of the shaping machine 200 can be calculated.

As shown in FIG. 1 and FIG. 2, in another embodiment, in the calculation that the evaluation device 102 generates the evaluation score, the evaluation device 102 can select the bolster plate position value, the motor current value and the machine temperature value from the numerical parameters, and obtain the weights corresponding to the bolster plate position value, the motor current value and the machine temperature value. Then, the evaluation device 102 can multiply the bolster plate position value, the motor current value and the machine temperature value with corresponding weights, respectively, and accumulate the weighted bolster plate position value, the weighted motor current value and the weighted machine temperature value as an evaluation score for this machining program. And the display 103 can display the score graph corresponding to the evaluation score. In the embodiment, the machine temperature value indicates the temperature measured from the oil tank of the shaping machine 200 in this machining program. The machine temperature value can be measured by the temperature sensor settled in the oil tank of the shaping machine 200. It is noted, the machine temperature value can be used to evaluate the stability of the shaping machine 200.

As shown in FIG. 1 and FIG. 2, in another embodiment, in the calculation that the evaluation device 102 generates the evaluation score, the evaluation device 102 can select the bolster plate position value, the motor current, the shaping pressure value, the shaping cycle time value and the machine temperature value from the numerical parameters, and obtain the weights corresponding to the bolster plate position value, the motor current, the shaping pressure value, the shaping cycle time value and the machine temperature value. Then, the evaluation device 102 can multiply the bolster plate position value, the motor current, the shaping pressure value, the shaping cycle time value and the machine temperature value with corresponding weights, respectively, and accumulate the weighted bolster plate position value, the weighted motor current, the weighted shaping pressure value, the weighted shaping cycle time value and the weighted machine temperature value as an evaluation score for this machining program. And the display 103 can display the score graph corresponding to the evaluation score.

As mentioned in above embodiments, in the calculation that the evaluation device 102 generates the evaluation score, the evaluation device 102 can select some of the bolster plate position value, the motor current, the shaping pressure value, the shaping cycle time value and the machine temperature value from the numerical parameters, and obtain the weights corresponding to these parameters. Then, the evaluation device 102 can multiply each of the selected parameters with one corresponding weight, respectively, and accumulate the weighted parameters as the evaluation score for this machining program. In one embodiment, each of the numerical parameters has a variation range. It is noted, larger the variation range is, smaller the value of the weight corresponding to that numerical parameter is. Usually, the variation range of each numerical parameter is related to the scale regarding that numerical parameter. For example, when shaping machine 200 is in operation, the scale for measuring the machine temperature value of the shaping machine 200 can be degree Celsius, which has a variation range that is relative stable. In comparison, the scale for measuring the bolster plate position value can be millimeters. Obviously, the variation that the bolster plate position value being measured can be much larger than the variation of the machine temperature value when the shaping machine 200 works normally. In this case, if same weights are assigned to both the machine temperature value and the bolster plate position value, it can be seen that variation of the machine temperature value cannot be reflected in the final evaluation score effectively. It is to say, in the embodiment, the machine temperature value having relative small variation can be given with larger weight, and the bolster plate position value having relative large variation can be given with smaller weight. Thus, the machine temperature value and the bolster plate position value can be both reflected in the final evaluation score effectively.

Furthermore, in some embodiments, after the evaluation device 102 runs the weight calculation to the selected numerical parameters, each weighted numerical parameters occupies similar percentage in the evaluation score. In these embodiments, the evaluation device 102 can display the evaluation score in percentage. For example, the evaluation device 102 can be display as a value, and the value is ranged from one to a hundred.

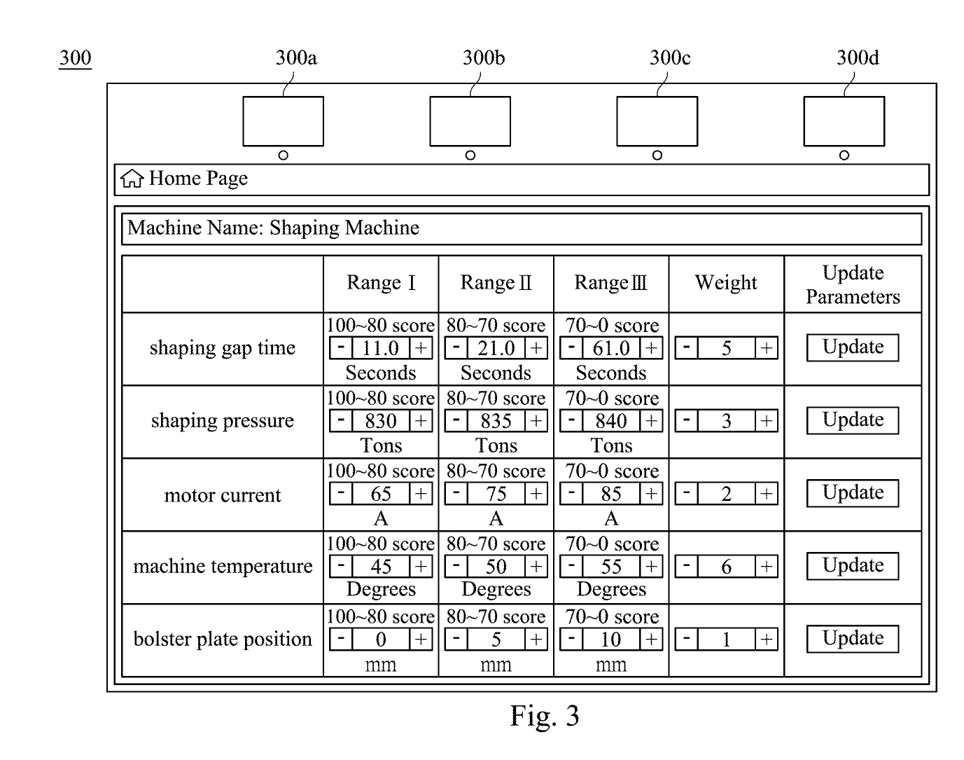

FIG. 3 is a schematic diagram of an evaluation setting table according to one embodiment of the present disclosure. FIG. 3 illustrates a setting page on which the evaluation setting table 300 is displayed. The evaluation setting table 300 is provided to set the evaluation settings or percentages corresponding to each numerical parameter in the evaluation score. The operator or manager of the shaping machine can adjust the evaluation settings and the weights corresponding to the numerical parameters. The reference can also be made to FIG. 1 and FIG. 2, in one embodiment, when the calculation of the evaluation score is performed, the evaluation device 102 can calculate at least one select numerical parameter to generate the evaluation score. As shown in FIG. 3, several machine icons 300a-300d, which are corresponding to several shaping machines, are displayed on the top row of the evaluation setting table 300. In the embodiment, when the evaluation device 102 runs the evaluation, it is the machine icon 300a being selected, and the evaluation setting table 300 shows the evaluation settings and weights corresponding to the numerical parameters of the shaping machine 200. It is noted, if the machine icons 300b-300d are selected by the user, the page can show the evaluation setting tables corresponding to the shaping machines associated with the machine icons 300b-300d.

In FIG. 3, the evaluation setting table 300 shows the evaluation settings and weights corresponding to the numerical parameters when the machine icon 300a is selected. The table shown at the down side of the evaluation setting table 300 includes several rows and columns. From the top to the bottom, the rows of the evaluation setting table 300 displays the numerical parameters, including: the shaping cycle time value, the shaping pressure value, the motor current, the machine temperature value and the bolster plate position value. From the left to the right, the columns of the evaluation setting table 300 displays the evaluation options to each numerical parameter, including: Range I, Range II, Range III, weight, and update parameters. Range I, Range II and Range III show the evaluation standards that the numerical parameters being evaluated in scores, from a high one to a low one. And the operator and manager of the shaping machine can adjust the evaluation standards for the numerical parameters in the evaluation setting table 300. For example, if the manager of the shaping machine believes that the shaping cycle time value shorter than 11 seconds should fall within Range I, the manager of the shaping machine can set the value of row 1 column 1 as 11, and click the “update” in the update parameters column to apply the setting. For example, if the manager of the shaping machine believes that the shaping pressure value lower than 835 tons should fall within Range II, the manager of the shaping machine can set the value of row 2 column 2 as 835, and click the “update” in the update parameters column to apply the setting. The rest of values in the evaluation setting table 300 can be settled in the same way and not repeated again. Moreover, it is noted, the values shown in the evaluation setting table 300 are merely examples. The scores and the weights corresponding to the numerical parameters are not limited thereto.

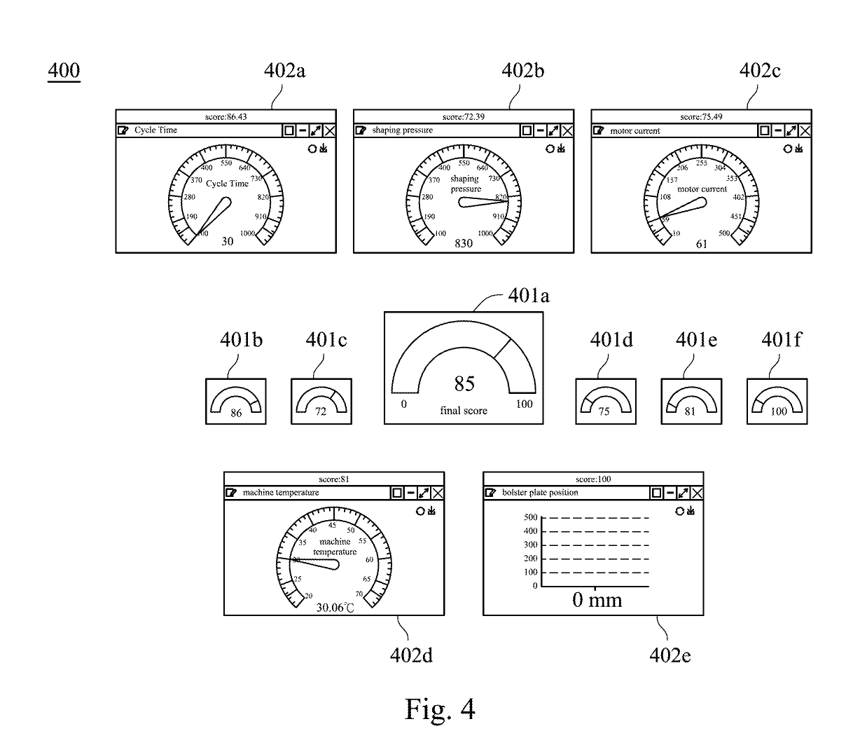

FIG. 4 is a schematic diagram of some evaluation graphs according to one embodiment of the present disclosure. FIG. 4 illustrates a setting page on which the evaluation graph 400 is displayed. The evaluation graph 400 graphically displays the values or percentages of the numerical parameters in the evaluation score. Through the evaluation graph 400, the operator and the manager of the shaping machine can read the evaluation scores corresponding to the numerical parameters faster. The reference can also be made to FIG. 1 and FIG. 2, in one embodiment, when the evaluation device 102 runs the evaluation score calculation, the evaluation device 102 calculates at least one select numerical parameters to generate the evaluation score. The evaluation device 102 can display the evaluation graph 400 on the display 103, then the the operator and the manager of the shaping machine can read the evaluation scores evaluation score. As shown in FIG. 4, the evaluation graph 400 includes several evaluation sub-graphs 401a˜401f. The evaluation sub-graph 401a shows the final evaluation score. The evaluation sub-graph 401b shows the evaluation score corresponding to the shaping cycle time value. The evaluation sub-graph 401c shows the evaluation score corresponding to the shaping pressure value. The evaluation sub-graph 401d shows the evaluation score corresponding to the motor current. The evaluation sub-graph 401e shows the evaluation score corresponding to the machine temperature value. The evaluation sub-graph 401f shows the evaluation score corresponding to the bolster plate position value. As can be seen in the figure, the value of the final evaluation score is a sum of the weighted evaluation scores as shown in the evaluation sub-graphs 401b˜402f.

Furthermore, the evaluation graph 400 includes several parameter graph 402a˜402e, which are being displayed as pressure meters or pointer gauges. The parameter graph 402a˜402e are provided to display the original values of the shaping cycle time value, the shaping pressure value, the motor current, the machine temperature value and the bolster plate position value before the weigh calculation is applied. In the embodiment, the parameter graph 402a shows the actual value of the shaping cycle time value of the shaping machine 200 when this machining program is performed. The parameter graph 402b shows the raw value of the shaping pressure value of the shaping machine 200 when this machining program is performed. The parameter graph 402c shows the raw value of the motor current value of the shaping machine 200 when this machining program is performed. The parameter graph 402d shows the raw value of the machine temperature value of the shaping machine 200 when this machining program is performed. The parameter graph 402e shows the raw value of the bolster plate position value of the shaping machine 200 when this machining program is performed.

It should be noted, in the embodiments of present disclosure, the evaluation device 102 can be a computing device including a processor (not shown) and a memory (not shown). Said computing device can be, but not limited to, smart phone, tablet, computer, etc. The processor of the evaluation device 102 can be electrically coupled to the parameter obtaining device 101 and the display 103 via some mediums, such as Bus, or even no medium. In the embodiment, the processor can be the central processing unit (CPU) of a computing device, which can be programed to interpret computer instructions, to process computer software, and to execute multiple computing procedures. In the embodiment, the memory of the evaluation device 102 includes primary storages and secondary storages. The processor of the evaluation device 102 is directly or indirectly coupled to the memory. The processor of the evaluation device 102 is configured to load instructions from the memory and to execute the instructions. Therefore, the evaluation device 102 can perform the functions described in foregoing embodiments, such as transforming the parameters into numerical and calculating the evaluation score.

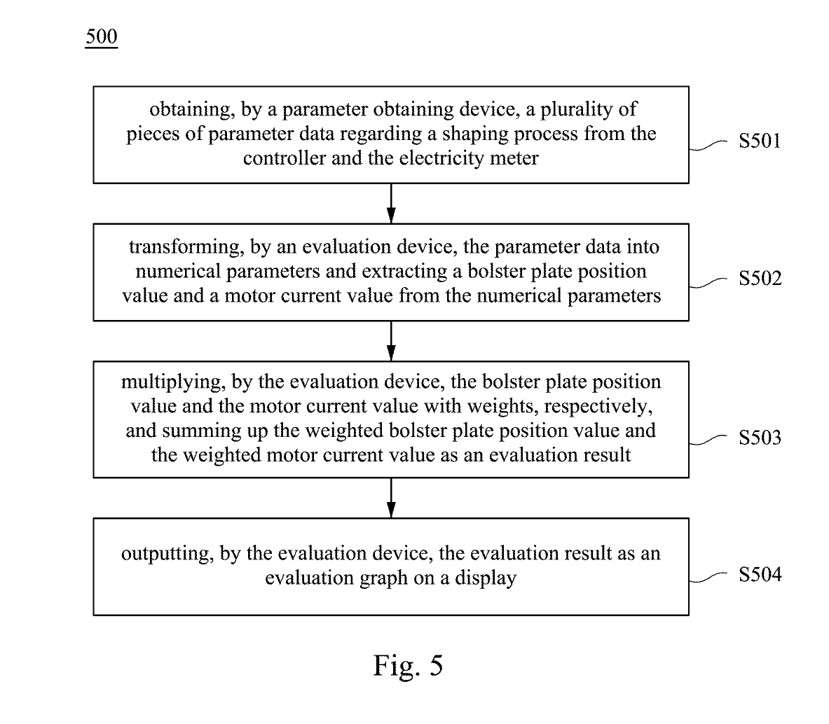

FIG. 5 is a flow chart of an evaluation method 500 according to some embodiments of present disclosure. In the embodiment, the evaluation system 100 is configured to apply the evaluation method 500 to the shaping machine 200. Regarding the evaluation system 100 and the shaping machine 200, the reference can be made to the embodiment of FIG. 1 and FIG. 2. In the embodiment, the steps of the evaluation method 500 will be listed in following paragraphs.

Step S501: obtaining, by a parameter obtaining device, a plurality of pieces of parameter data regarding a machining program from the controller and the electricity meter. As shown in FIG. 1 and FIG. 2, in one embodiment, the shaping machine 200 includes the controller 201 and the electricity meter 202. When the execution button is pressed by the operator, the controller 201 sends the control signal to drive the stamping part of the shaping machine 200 to execute the machining program. The control signal includes data regarding a plurality of parameters. When the machining program is performed, the controller 201 can retrieve feedbacks and parameters regarding the machining program from the sensors settled on the shaping machine 200. In the embodiment, the evaluation system 100 includes the parameter obtaining device 101 and the evaluation device 102 that are electrically coupled to each other. When the machining program is performed, the parameter obtaining device 101 can obtain the parameter data from the controller 201 and the electricity meter 202. In the embodiment, when the parameter obtaining device 101 successfully obtains the parameter data from the controller 201, the parameter obtaining device 101 can send the parameter data to the evaluation device 102 of the evaluation system 100. Then, the evaluation device 102 can process the parameter data.

Step S502: transforming, by an evaluation device, the parameter data into numerical parameters and extracting a bolster plate position value and a motor current value from the numerical parameters. As shown in FIG. 1 and FIG. 2, in one embodiment, when the evaluation device 102 of the evaluation system 100 receives the parameter data sent by the parameter obtaining device 101, the evaluation device 102 transforms the parameter data into numerical parameters. Thus, the numerical parameters regarding the machining program performed by the shaping machine 200 can be obtained. In the embodiment, the numerical parameters at least include the bolster plate position value and the motor current value of the shaping machine 200. It is noted, in some embodiments, the numerical parameters further include the shaping pressure value, the shaping cycle time value, and the machine temperature value of the shaping machine 200.

Step S503: multiplying, by the evaluation device, the bolster plate position value and the motor current value with weights, respectively, and summing up the weighted bolster plate position value and the weighted motor current value as an evaluation score. As shown in FIG. 1 and FIG. 2, in one embodiment, the evaluation device 102 obtains the bolster plate position value and the motor current value of the shaping machine 200, and the evaluation device 102 can obtain the weights corresponding to the bolster plate position value and the motor current value from the predetermined weight table. Then, the evaluation device 102 can multiply the bolster plate position value and the motor current value with corresponding weights, respectively, and sum up the weighted bolster plate position value and the weighted motor current value as the evaluation score. It is noted, in some embodiments, the numerical parameters further include the shaping pressure value, the shaping cycle time value and the machine temperature value of the shaping machine 200, and the evaluation device 102 can multiply the bolster plate position value, the motor current, the shaping pressure value, the shaping cycle time value and the machine temperature value with corresponding weights, respectively, and sum up the weighted parameters as the evaluation score. Moreover, in some embodiments, each of the bolster plate position value, the motor current, the shaping pressure value, the shaping cycle time value and the machine temperature value obtained by the evaluation device 102 has the corresponding variation range. Larger the variation range is, smaller the value of the weight corresponding to that numerical parameter is.

Step S504: outputting, by the evaluation device, the evaluation score as an evaluation graph on the display. As shown in FIG. 1 and FIG. 2, in foregoing embodiments, when the evaluation device 102 generates the evaluation score for the machining program, the evaluation device 102 can display the evaluation graph, such as the evaluation graph 400 shown in FIG. 4, on the display 103. As shown in FIG. 4, the evaluation graph 400 includes several evaluation sub-graphs 401a˜401f, in which the evaluation sub-graphs 401b˜402f shows the evaluation score corresponding to the bolster plate position value, the motor current, the shaping pressure value, the shaping cycle time value and the machine temperature value. The evaluation sub-graph 401a shows the final evaluation score which is the sum of the weight evaluation scores shown in the evaluation sub-graphs 401b˜402f.

In foregoing embodiments, present disclosure provides an approach with advantages as follows. The evaluation system and evaluation method in forgoing embodiments provides a way to turn parameters regarding one machining program into numerical scores. It is an intuitive way to present whether the machining program is good or bad. Moreover, the evaluation score can be shown on the display, so the operator or the manager of the shaping machine can read the evaluation score conveniently.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An evaluation system, applied on a shaping machine having a controller and an electricity meter, comprising:
a parameter obtaining device, communicatively coupled to the controller and the electricity meter, the parameter obtaining device configured to obtain a plurality of pieces of parameter data regarding a machining program from the controller and the electricity meter; and
an evaluation device, electrically coupled to the parameter obtaining device, the evaluation device configured to transform the parameter data into numerical parameters, extract a bolster plate position value of the shaping machine and a motor current value of the shaping machine from the numerical parameters, multiply the bolster plate position value with a first weight, multiply the motor current value with a second weight, and sum up the weighted bolster plate position value and the weighted motor current value as an evaluation score.

2. The evaluation system of claim 1, wherein the evaluation device obtains a plurality of pieces of historical parameter data regarding at least one historical machining program of the machining program, extracts a plurality of historical bolster plate position values and a plurality of historical motor current values from the historical parameter data, and determines the first weight and the second weight based on the historical bolster plate position values and the historical motor current values.

3. The evaluation system of claim 1, wherein the evaluation device determines the first weight and the second weight based on at least one predetermined weight table.

4. The evaluation system of claim 1, wherein the evaluation device is electrically coupled to a display for outputting the evaluation score as a score graph on the display.

5. The evaluation system of claim 1, wherein in respond to the evaluation device transforms the parameter data into numerical parameters, the evaluation device further extracts a shaping pressure value from the numerical parameters, and the evaluation device multiplies the bolster plate position value with the first weight, multiplies the motor current value with the second weight, multiplies the shaping pressure value with a third weight, and sum up the weighted bolster plate position value, the weighted motor current value and the weighted shaping pressure value as the evaluation score.

6. The evaluation system of claim 1, wherein in respond to the evaluation device transforms the parameter data into numerical parameters, the evaluation device further extracts a shaping cycle time value from the numerical parameters, and the evaluation device multiplies the bolster plate position value with the first weight, multiplies the motor current value with the second weight, multiplies the shaping cycle time value with a fourth weight, and sum up the weighted bolster plate position value, the weighted motor current value and the weighted shaping cycle time value as the evaluation score.

7. The evaluation system of claim 1, wherein in respond to the evaluation device transforms the parameter data into numerical parameters, the evaluation device further extracts a machine temperature value from the numerical parameters, and the evaluation device multiplies the bolster plate position value with the first weight, multiplies the motor current value with the second weight, multiplies the machine temperature value with a fifth weight, and sum up the weighted bolster plate position value, the weighted motor current value and the weighted machine temperature value as the evaluation score.

8. The evaluation system of claim 1, wherein each of the numerical parameters has a variation range, the variation range of the bolster plate position value is inversely proportional to the first weight, and the variation range of the motor current value is inversely proportional to the second weight.

9. An evaluation method, applied on a shaping machine having a controller and an electricity meter, the monitoring method comprises:
obtaining, by a parameter obtaining device, a plurality of pieces of parameter data regarding a machining program from the controller and the electricity meter;
transforming, by an evaluation device, the parameter data into numerical parameters and extracting a bolster plate position value of the shaping machine and a motor current value of the shaping machine from the numerical parameters; and
multiplying, by the evaluation device, the bolster plate position value with a first weight and multiplying the motor current value with a second weight, and summing up the weighted bolster plate position value and the weighted motor current value as an evaluation score.

10. The evaluation method of claim 9, further comprising:
obtaining, by the evaluation device, a plurality of pieces of historical parameter data regarding at least one historical machining program, and extracting a plurality of historical bolster plate position values and a plurality of historical motor current values from the historical parameter data, and determining the first weight and the second weight based on the historical bolster plate position values and the historical motor current values.

11. The evaluation method of claim 9, further comprising:
determining, by the evaluation device, the first weight and the second weight based on at least one predetermined weight table.

12. The evaluation method of claim 9, further comprising:
outputting, by the evaluation device, the evaluation score as an evaluation graph on a display.

13. The evaluation method of claim 9, further comprising:
in respond to the evaluation device transforms the parameter data into the numerical parameters, extracting, by the evaluation device, a shaping pressure value from the numerical parameters; and
multiplying, by the evaluation device, the bolster plate position value with the first weight, multiplying the motor current value with the second weight, multiplying the shaping pressure value with a third weight, respectively, and summing up the weighted bolster plate position value, the weighted motor current value and the weighted shaping pressure value as the evaluation score.

14. The evaluation method of claim 9, further comprising:
in respond to the evaluation device transforms the parameter data into the numerical parameters, extracting, by the evaluation device, a shaping cycle time value from the numerical parameters; and
multiplying, by the evaluation device, the bolster plate position value with the first weight, multiplying the motor current value with the second weight, multiplying the shaping cycle time value with a third weight, and summing up the weighted bolster plate position value, the weighted motor current value and the weighted shaping cycle time value as the evaluation score.

15. The evaluation method of claim 9, further comprising:
in respond to the evaluation device transforms the parameter data into the numerical parameters, extracting, by the evaluation device, a machine temperature value from the numerical parameters; and
multiplying, by the evaluation device, the bolster plate position value with the first weight, multiplying the motor current value with the second weight, multiplying the machine temperature value with a third weight, and summing up the weighted bolster plate position value, the weighted motor current value and the weighted machine temperature value as the evaluation score.

16. The evaluation method of claim 9, wherein each of the numerical parameters has a variation range, and the variation range of the bolster plate position value is inversely proportional to the first weight, and the variation range of the motor current value is inversely proportional to the second weight.
